(19) United States
(12) Patent Application Publication
(10) Pub. No.: US 2010/0169223 A1
(43) Pub. Date: Jul. 1, 2010

(54) Payment System and Method Using an IC Identification Card

(75) Inventor: Leiming Yuan, Hangzhou (CN)

Correspondence Address: LEE & HAYES, PLLC, 601 W. RIVERSIDE AVENUE, SUITE 1400, SPOKANE, WA, 99201, US

(73) Assignee: ALIBABA GROUP HOLDING LIMITED, Grand Cayman (KY)

(21) Appl. No.: 12/097,503

(22) PCT Filed: Jun. 11, 2008
(86) PCT No.: PCT/US2008/066581

§ 371 Date: Dec. 15, 2009

(30) Foreign Application Priority Data
Jun. 13, 2007 (CN) 200710112394.X

(51) Int. Cl. H04L 9/32; G06Q 40/00; G06Q 20/00; G06F 17/30; G06K 7/00; G06F 15/16

(52) U.S. Cl. 705/67; 707/812; 235/379; 709/201; 707/E17.045

(57) ABSTRACT

A payment system utilizes an IC identification card to identify a user, finds and verifies a bank account of the user. The system uses an IC identification card reader to read user identity information, and sends it along with user bank account information to an intermediary platform to be processed. The intermediary platform sends the received user identity information along with the other bank transaction information as part of a bank transaction request to a participating bank subsystem to be processed. The participating bank subsystem conducts the requested bank transaction with a user bank account determined according to the user identification either by the intermediary platform or by the participating bank subsystem based on a mapping relationship between the user identity and bank accounts. The decryption of the user identification information is done either by the IC identification card reader or at the intermediary platform.

### RELATED APPLICATIONS

This application is a national stage application of international patent application PCT/US08/66581, filed Jun. 11, 2008, claiming priority from Chinese patent application, Application No. 200710112394.X, filed Jun. 13, 2007, entitled “PAYMENT SYSTEM AND METHOD USING IC IDENTIFICATION CARD”.

### BACKGROUND

This disclosure is related to the field of data processing technologies, and particularly a payment system and a method for trading using an IC identification card.

As it is inconvenient and unsafe to carry lots of cash around, bank cards have been used widely for many different transaction occasions. More and more people are using bank cards for shopping. FIG. 1 shows a schematic block representation of an existing payment system that uses a bank card for processing transaction. In this existing system, there are a receiving terminal 113 which reads bank card information, a merchant subsystem 112, and an acquiring subsystem 111. The merchant subsystem 112 usually has a server and several customer terminals (not shown). The customer terminals at the merchant subsystem 112 connect to the receiving terminal 113 while the server of the merchant subsystem 112 connects to the acquiring subsystem 111 of an acquirer through a special designated line. When the acquirer of the acquiring subsystem 111 and participating bank are not the same, a connection from the acquiring subsystem 111 to the acquiring subsystem (not shown) of the participating bank is further made through an inter-bank trading subsystem of partnering banks (such as UnionPay of China).

When a user uses a bank card to make a payment using the payment of FIG. 1, receiving terminal 113 (e.g., a cash register) first verifies the authenticity of the bank card based on the readability of the bank card. Afterwards, customer terminal of merchant subsystem 112 transmits identity information (which has been entered by the user to present the user identity), the bank card number and other merchant transaction information to a server of merchant subsystem 112. The server of the merchant subsystem 112 subsequently sends the information to acquiring subsystem 111. If acquirer and participating bank are the same, the acquiring subsystem 111 processes the transaction directly. Otherwise, this information is sent to the participating bank through an inter-bank trading subsystem. A participating bank subsystem uses the bank card information and the identity information to verify the identity of the user. If identity is validated, the participating bank subsystem processes a deduction from an account of the card number, and returns a bank transaction result of this deduction. If verification fails, the participating bank subsystem returns a message indicating that the identity cannot be verified. After the merchant subsystem 112 receives the message that deduction was successfully made, the merchant can then allow the customer (the user) to sign a sales slip for validation.

The above description shows the most common payment transaction process in the existing technologies. However, this payment process has certain flaws as discussed below.

In the payment process of FIG. 1, a bank card with a combination of account name and password are used to authenticate the user identity in the whole transaction. The method of authentication of a bank card by terminals such as Point-Of-Sales (POS) and Automated Teller Machine (ATM) in existing technologies has posed very high risks. Current bank cards are made using magnetic strip card technology. Since the anti-counterfeit capability of magnetic strip cards is low, these cards may be easily imitated or counterfeited.

As a result, smart card has been proposed recently to replace the magnetic strip card as a new generation of the bank card. A smart card, also called chip card, integrated circuit (IC) card, or simply IC card, is a pocket-sized card with embedded integrated circuits which can process information. A smart card can receive an input, process the input, and deliver it as an output. The card is made of plastic, generally PVC, but sometimes ABS. The card may embed a hologram to avoid counterfeiting. For example, one can use EMV technology to produce smart card. EMV is a standard for smart IC bank card technology developed together by international bank card organizations such as Europay, Master and Visa. This standard requires a CPU chip of the bank card to have standalone operations, encryption and decryption functions, as well as storage capability, thereby achieving a higher level of security.

However, the transformation of bank card from magnetic strip card to smart card has proven to be very costly and slow. The cost to manufacture a smart card is many times higher than that of a magnetic strip card. In addition, it is very expensive to modify the existing POS and ATM so that they can read smart cards. Even if the bank card's transformation from magnetic strip card to smart card could be made despite the huge cost of money and resources, penetrators could still be motivated to forge smart cards due to the existence of large profits. Furthermore, even though terminals such as ATM and POS may read a bank card and verify its authenticity, they cannot confirm whether the bank card is the same bank card issued by a financial institution to the user, or whether the rightful user is using the smart card issued by the financial institution. Because there is no other practical ways to verify user identity, if penetrators obtain user information such as password, serious financial losses to the user and merchant may follow. In the existing technologies, after ATM and POS have received a bank account password entered by the user and read the bank account information of the bank card, usually only the bank account password is encrypted before it is transmitted over the network. Important financial information such as bank account numbers and transaction amounts are sent in plaintext format. If a penetrator has obtained the bank account password through illegal means, it becomes very easy to obtain the financial information such as bank account numbers, potentially leading to financial losses for the real users and greatly reducing the security of bank transactions.

From another perspective, the transformation of bank card from magnetic strip card to smart card will not happen overnight. As such, there is a need for another practical method of verifying user identities in a payment process to guarantee the security of the transaction.

### SUMMARY

This disclosure provides a payment system and a method for trading using an IC identification card in order to solve the problem of low security in existing technologies that uses a bank card for processing transaction.

A payment system utilizes an IC identification card to identify a user, finds and verifies a bank account of the user. The system uses an IC identification card reader to read user identity information, and sends it along with user bank account information to an intermediary platform to be processed. The intermediary platform sends the received user identity information along with the other bank transaction information as part of a bank transaction request to a participating bank subsystem to be processed. The participating bank subsystem conducts the requested bank transaction with a user bank account determined according to the user identification either by the intermediary platform or by the participating bank subsystem based on a mapping relationship between the user identity and bank accounts. The decryption of the user identification information is done either by the IC identification card reader or at the intermediary platform.

The intermediary platform may obtain the user bank account number based on the mapping relationship between the user identity information and bank accounts, and include the user bank account number in the bank transaction information sent to the participating bank subsystem. If the bank transaction information does not contain a bank account number, the participating bank subsystem may look up the bank account number corresponding to the user identification card number, verifies bank account password after decryption, processes the transaction and returns a bank transaction result.

In some embodiments, an input unit is used for receiving the user bank account information such as a bank account password. The input unit may also be used for receiving merchant transaction information such as transaction amount.

Various encryption schemes may be used to enhance security. An IC identification card may contain encrypted user identification information such as a user identification card number in addition to non-encrypted user identification information such as a printed photo. A decryption system is used to verify the authenticity of the IC identification card by decrypting the encrypted user identification information. In one type of embodiments, the decryption of the user identification information takes place at the intermediary platform. In an alternate type of embodiments, the decryption of the user identification information is done by the IC identification card reader.

In one embodiment, the accepting device of the payment system has a cipher used for encrypting the user bank account information (such as a user bank account password) using a bank encryption key provided by either the participating bank or a third party. Another cipher may also be optionally used for encrypting the transaction amount. At the intermediary platform, the user identification information and the transaction amount are decrypted by a matching decryption key. The encrypted user bank account password may be passed by the intermediary platform onto the participating bank subsystem to be decrypted and verified. Alternatively, the user bank account password may be decrypted by the intermediary platform and subsequently sent to the participating bank subsystem. Furthermore, the intermediary platform may also encrypt the bank transaction information before sending it to the participating bank subsystem to be decrypted, verified and applied.

Using an IC identification card for payment transaction, the disclosed payment system and method benefits from the high-quality encryption, high safety and widespread use of the IC identification cards (the second-generation identification cards in some countries) to reduce costs and enhance security.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 shows a schematic block representation of an existing payment system that uses a bank card for processing transaction.

FIG. 2 is a schematic block representation of an exemplary payment system using an IC identification card in accordance with the present disclosure.

FIGS. 2A and 2B are schematic block representations of type I and type II implementations of the exemplary payment system of FIG. 2.

FIG. 3A, 3B, 3C, 3D and 3E illustrate several different configurations of the accepting device in accordance with the present disclosure.

FIG. 4 is a schematic diagram of an exemplary accepting device in accordance with the present disclosure.

FIG. 5 show a schematic block representations of an exemplary accepting device using a computer interfacing with an IC card reader.

FIG. 6 is a schematic block representation of an exemplary accepting device having a separate ciphering unit.

FIG. 7 shows further detail of an intermediary platform of the present payment system.

FIG. 8 is a flow chart of an exemplary process of the payment method using an IC identification card.

FIG. 9 illustrates an exemplary process of the payment method using Alipay payment platform as the intermediary platform.

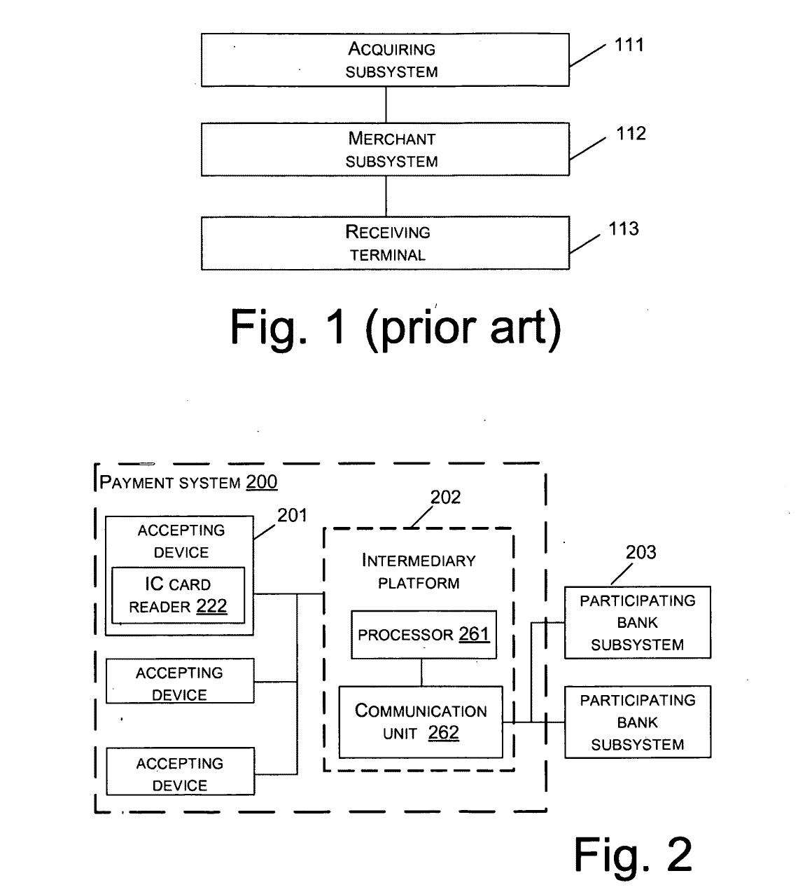

### DETAILED DESCRIPTION

The payment system and method use an IC identification card (an identification card having an IC chip or an IC card used as identification) such as second-generation identification cards used in some countries (e.g. China) for processing payment transaction. The disclosed payment system and method take advantage of the features (such as high-quality encryption and widespread use) of the IC identification cards which are already been widely used in some countries and regions, and quickly becoming many more countries and regions. One advantage of IC identification cards over smart bank cards is that the former may have widespread use already, and if not will soon in some countries, regardless of any commercial use of them for business transactions. Because IC identification cards are implemented by the government, they tend to have a high degree of penetration in the population and fewer obstacles to obtain a uniform standard in both hardware and software implementation. In contrast, smart bank cards are manufactured and issued by each issuing financial institution to their customers, often in addition to the already existing IC identification cards. For users who are customers of multiple banks, multiple smart bank cards may need to be made for them. If the banks don't collaborate with each other, not only will there be multiplicity of the smart bank cards, but also different standards and technologies used for different smart bank cards.

As will be illustrated, the disclosed payment system and method establishes a payment procedure at least as secure as that of a smart bank card without incurring the high costs of fabricating the smart bank cards and establishing a separate network of accepting machines for smart bank cards. Using encryption keys in the whole transaction process is some embodiments may further reinforce the security. The disclosed payment system and method may be combined with the use of an existing bank card (such as a conventional magnetic strip card) for further convenience.

Compared with the first-generation identification cards, the anti-counterfeit function of the second-generation identification card has been improved. One exemplary second-generation identification card is made up of nine layers. The two outermost layers record personal identity information, which is printed onto the layers. There is another layer called balancing layer, which is used to guard against static electricity. On the balancing layer, there is an anti-counterfeit film bearing an image and/or logo which can often be holographic. For example, a second-generation identification card used in China bears an image of the Great Wall Beacon Tower and the logo “CHINA” (in Chinese characters). This anti-counterfeit film consists of orange and green anti-counterfeit marks and is developed from a relatively advanced technology. This balancing layer has an IC chip which is eight millimeter long, five millimeter wide and 0.4 millimeter thick. The balancing layer also has two antennas which are coils. The balancing layer is used to avoid personal information from leaking while allowing personal information being read by a designated card reader.

From the perspective of a security function, the new generation IC identification card has two anti-counterfeit measures. One is a digital anti-counterfeit measure which writes personal information into the chip after digital encryption. The anti-counterfeit digital encryption used in this part is generally developed and/or approved by a government agency to ensure that the authorized IC card readers will not recognize the information in the chip unless the information has been properly and legally encrypted by an authorized party. For example, the anti-counterfeit technology for the second-generation identification cards used in China is developed with the national security in consideration and has very high security characteristics. In one example, each geographical region (e.g., a province) has a regional password and each citizen has an individual password.

Another anti-counterfeit measure used in the new generation IC identification cards is anti-forgery printing technology. Both sides of the IC identification card may have printed patterns which are difficult to reproduce. This anti-forgery printing technology may use many different measures, including holograms.

Because of the adoption of digital anti-counterfeit measure and anti-forgery printing measure, the security is greatly increased with the IC identification cards. In addition, because personal identification cards used nationwide touch an important issue of national security, the corresponding card readers are also under tight security control by the government, further increasing the security. For example, in China, in order to improve security of the next generation national personal edification cards, the card readers are solely developed by the Ministry of Public Security of China and is provided to government designated contracted third party vendors only, leaving very little chance for the card reader to be compromised.

Along with the emergence of the second-generation identification cards in some countries and regions, card readers that can read IC identification cards are becoming increasingly available.

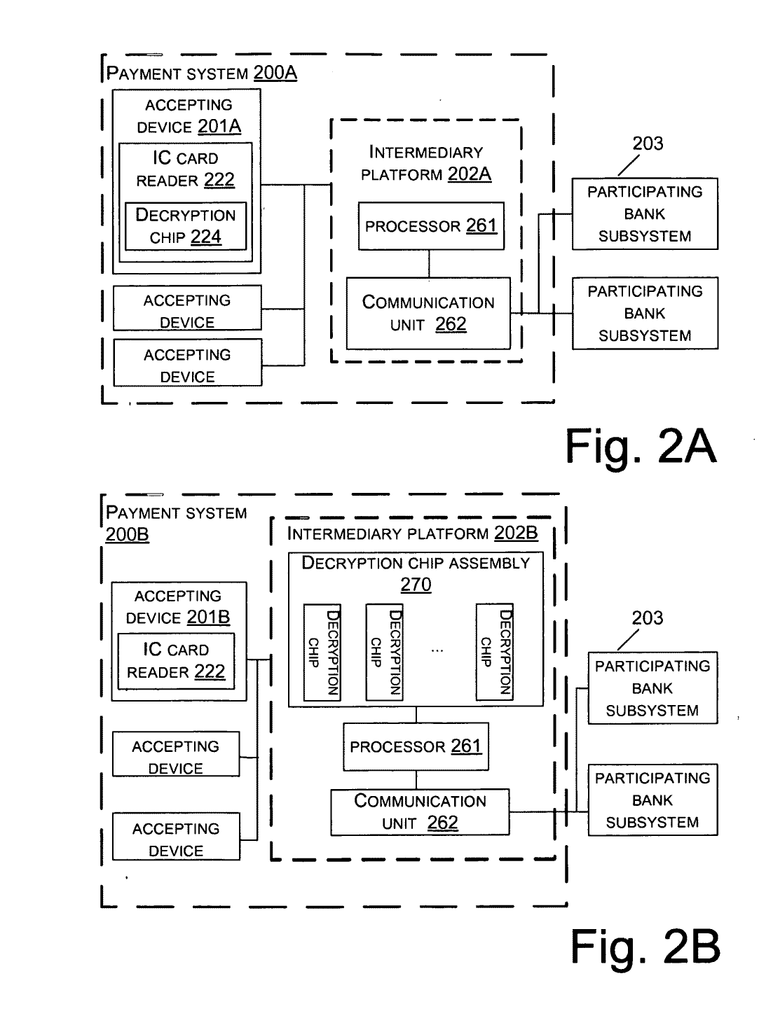

FIG. 2 is a schematic block representation of an exemplary payment system using an IC identification card in accordance with the present disclosure. The payment system 200 includes several accepting devices 201 and an intermediary platform 202. The payment system 200 communicates with participating bank subsystems 203 to conduct a bank transaction for making a payment. Each accepting device 201 may represent a merchant doing business with a customer (user) who has a bank account with the participating bank.

The accepting device 201 is adapted for receiving a user identity information, a user bank account information. The user identity information includes a user identification card number read from the user's IC identification card by an IC identification card reader 222, but may also include other user identification information (e.g., a printed photo war a digital photo of the cardholder) which may be either read by physical eyes for from the IC identification card by the IC identification card reader 222, or entered through other means. In a very basic form, an IC identification card may bear a printed photo of the cardholder which can be used for a visual verification of the cardholder by a merchant. In a preferred embodiment, at least part of the user identification information stored in an IC identification card is encrypted. The encryption of the user identification information provides a more secure verification of the authenticity of the IC identification card, either in addition to or in place of the visual verification.

The intermediary platform 202 includes a platform processor 261 and communication unit 262. The intermediary platform 202 receives the user identity information and the user bank account information sent from the accepting device 201. The intermediary platform 202 communicates a bank transaction information including the user identity information and the user bank account information to a participating bank system 203 to request a bank transaction. Subsequently, the intermediary platform 202 receives a bank transaction result from the participating bank system 203, and further communicates the bank transaction result to the accepting device 201 to complete the payment.

The intermediary platform 202 intermediates between the communication of the accepting device 201 and the participating bank subsystems 203. The accepting device 201 does not need to directly connect to the banks, but instead communicates with the banks through the intermediary platform 202.

As will be shown below, depending on the manner of decryption of the encrypted user identification information, there can be two different types of implementation.

FIGS. 2A and 2B are schematic block representations of type I and type II implementations of the exemplary payment system 200 of FIG. 2. Payment system 200A of FIG. 2A is a type I implementation, while payment system 200B of FIG. 2B is a type II implementation. In type I implementation as shown in FIG. 2A, the decryption of the user identification information is done at each accepting device 201A using the respective IC identification card reader 222 which has a decryption chip 224. The intermediary platform 202A is not required to have a decryption device to decrypt the user identification information (unless the user identification information is encrypted again at the accepting device 201A before it is sent to intermediary platform 202A). In the type II implementation, the decryption of the user identification information is done at the intermediary platform 202B using decryption chip assembly 270 contained therein. The accepting device 201B may simply pass the encrypted user identification information to the intermediary platform 202B to be decrypted, and is therefore not required to have a decryption device to decrypt the user identification information.

One advantage of the type I implementation is that the IC identification card readers having capabilities to decrypt the user identification information in IC identification cards are already commercially available in some countries (e.g., China), leaving a much lower barrier to implement the payment system described herein. However, the type I implementation may have a disadvantage of higher cost due to its use of local decryption which requires a decryption module (e.g., decryption chip 224) in each payment accepting unit (at a merchant location). With local decryption, the decryption equipment implemented at each payment accepting unit may not have full usage. In addition, local decryption may provide a secure verification of the cardholder by a merchant, but may be subjected to abuse by the merchant who may use another person's identification information to comment a fraud using the payment system.

In contrast, the type II implementation uses a centralized decryption with decryption modules (263) implemented at the intermediary platform (202B) which conducts transactions with numerous payment accepting units (merchants). Multiple parallel decryption modules (chips) may be used together at the intermediary platform for efficient and fast decryption. In addition, because in the type II implementation merchants have no access to the technology and equipment for decryption of identification information on IC identification cards, it is difficult for merchants to abuse the payment system by forging encrypted user identification information, thus making the payment system more secure. However, the type II implementation may face a higher technical barrier than the first type because there may be no commercially available ready-made solutions for decryption at an intermediary platform. Instead, the owner of the payment system may need to first work with the government authorization entities to receive the authorization to implement decryption modules an intermediary platform and then developed such an intermediary platform with capability to decrypt identification information read from IC identification cards.

In one embodiment, a combination of both type I and type II may be used in which both the accepting device and the intermediary platform have ability to decrypt and/or encrypt the user identification information. For example, the user authentication information may be decrypted using a first decryption algorithm matching the encryption algorithm of the IC identification card. The decrypted identification information may be used by the merchant at the accepting device to verify authenticity of the IC identification card. Thereafter, the decrypted identification information may be encrypted again using a second encryption algorithm before sent to the intermediary platform for secure data transmission. The second encryption algorithm may or may not be the same as the first encryption algorithm. In particular, the second encryption algorithm may be determined by the owner of the intermediary platform and agreed by the merchant, and does not have to meet the standard and the requirement imposed by the IC card issuer (typically a government agency) to match the original encryption algorithm used on the IC identification card.

### Accepting Device

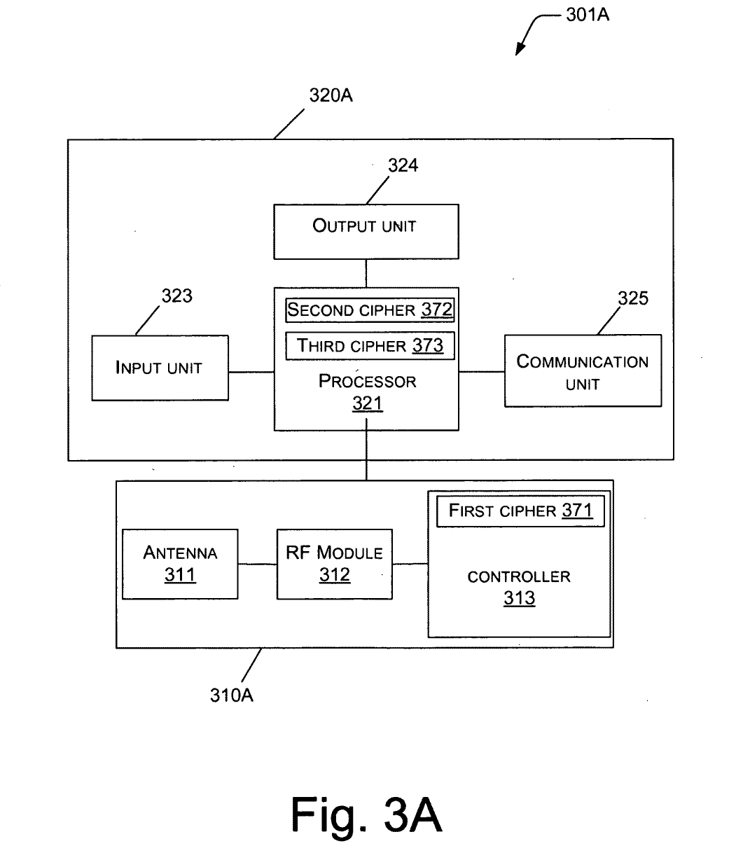

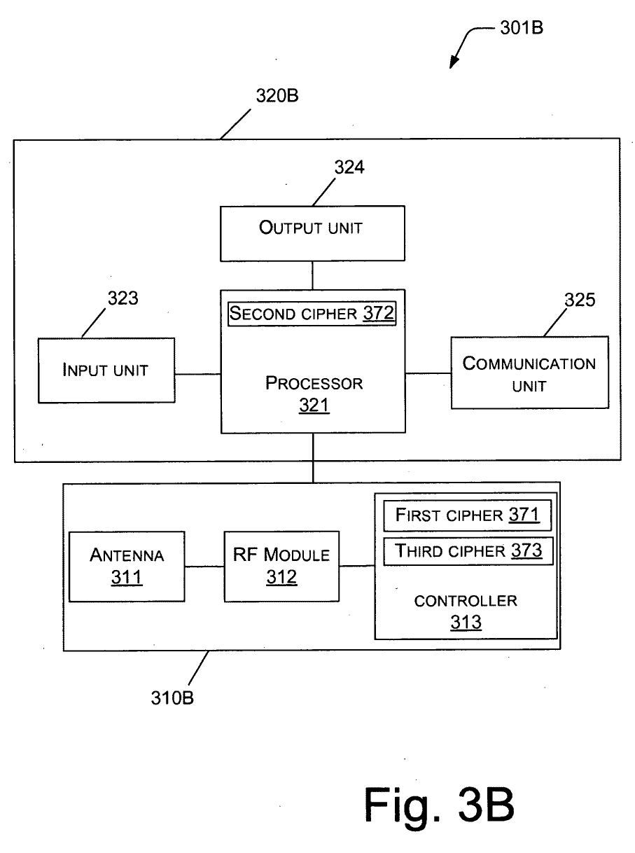

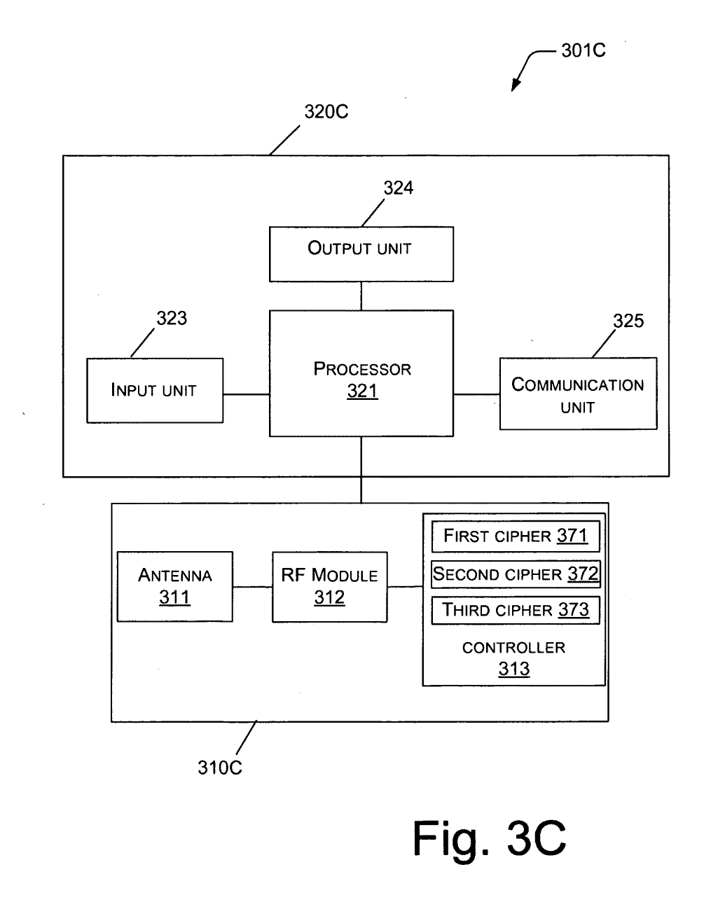

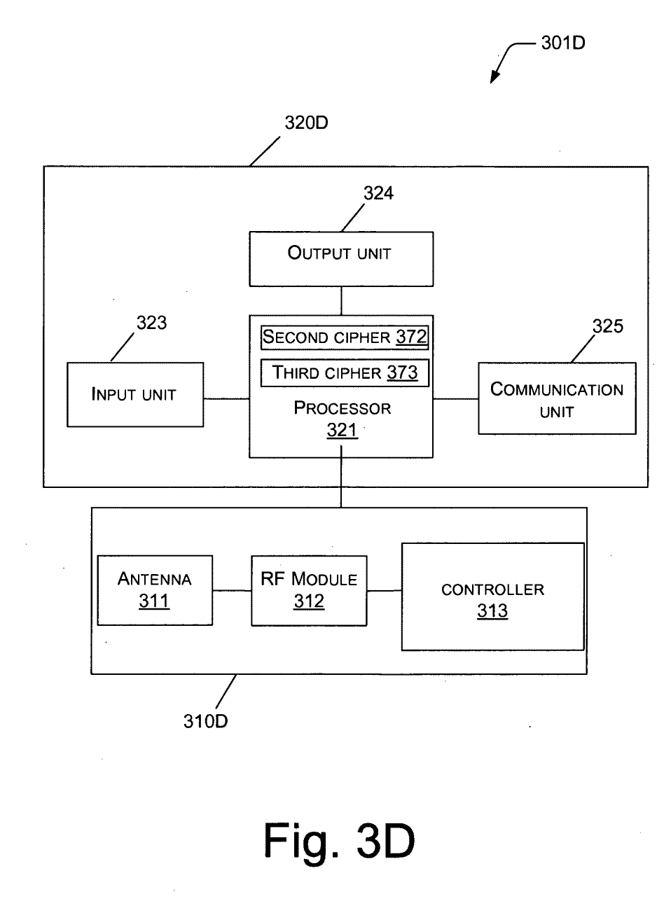

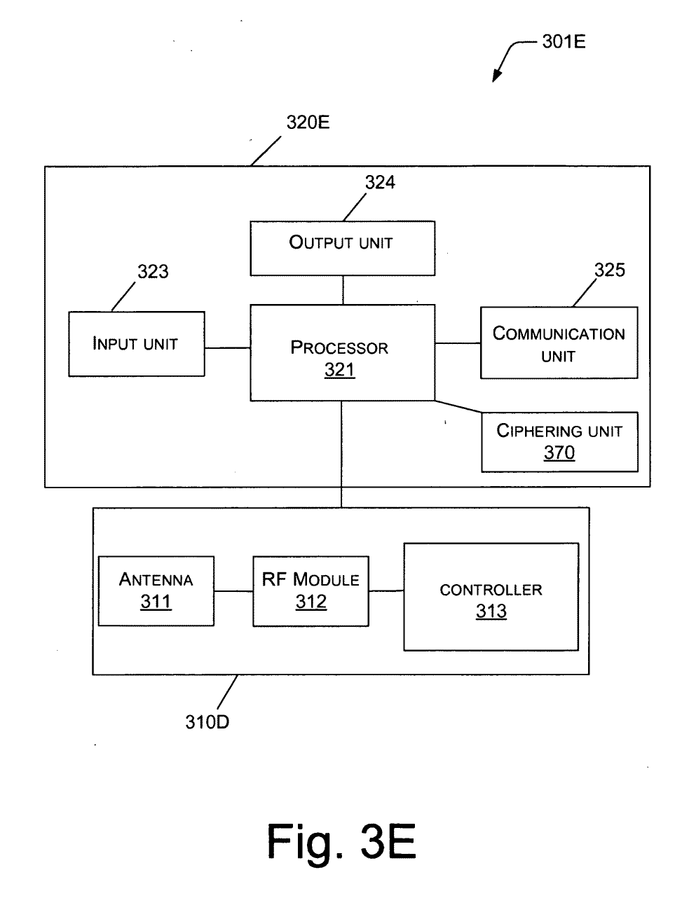

In the following, both the type I implementation and the type II implementation are illustrated using exemplary embodiments with reference to FIGS. 3-6.

FIG. 3A, 3B, 3C, 3D and 3E illustrate several different configurations of an accepting device in accordance with the present disclosure. The accepting devices 301A, 301B, 301C, 301D and 301E of FIGS. 3A, 3B, 3C, 3D and 3E should be understood with reference to the payment system 200 of FIGS. 2, 2A and 2B by substituting one of the accepting devices 201 in FIGS. 2, 2A and 2B with the respective accepting device 301A, 301B, 301C, 301D or 301E of FIGS. 3A, 3B, 3C, 3D or 3E.

In type I implementation, the accepting device (such as 301A, 301B and 301C of FIGS. 3A, 3B and 3C) has a decryption device first cipher 371 suited for decrypting identity information read from an IC identification card. In this case, the decryption result (e.g., whether the decryption is successful or not) is used by the accepting device to verify the authenticity of the IC identification card. The decrypted identification information may be sent to the intermediary platform for further action. Depending on the configuration and requirements of the intermediary platform, the user identification information may be encrypted again before being sent to the intermediary platform.

In type II implementation, the accepting device (such as 301D and 301E of FIGS. 3D and 3E) does not have a cipher for decrypting identity information read from an IC identification card. In this case, the encrypted identity information is passed to the intermediary platform 202B to be decrypted by decryption chip assembly 263.

FIG. 3A shows a schematic block representation of a first exemplary configuration of the accepting device in accordance with the present disclosure. The accepting device 301A has an identification card reader 310A and a merchant processing unit 320A, which includes an acceptor processor 321, a communication unit 325, an input unit 323, and an output unit 324.

The identification card reader 310A is used to read user identity information in user's IC identification card. An exemplary type of user identification information is a user identification card number. Some IC identification cards may also include a printed photo or a digital photo of the cardholder (user) in the user identity information. Digital user identity information such as a user identification card number, personal information (name, date of birth, etc.) of the cardholder, and digital photo may be encrypted using a designated encryption technique. In some embodiments, the identification card reader 310A may also incorporate capabilities of reading a conventional bank card to intake bank account information of the user, in addition to reading the user's IC identification card.

The input unit 323 is used for further receiving merchant transaction information such as a transaction amount. The input unit 323 may also be used for receiving further information from the user. For example, the input unit 323 may be used for entering bank account information associated with a conventional bank card.

The user may also enter a bank account password, either through the input unit 323 or the IC card reader 310A, depending on the configuration. If the IC card reader 310A does not come with an integrated user input, a separate input unit 323 may be used for entering such information as a bank account password. The input 323 may also be used for receiving information of the participating bank chosen by the user for payment.

The identification card reader 310A reads user identity information of an IC identification card. The identification card reader 310A in FIG. 3A has an antenna 311, a RF module 312 and a controller 313. The antenna 311 connects to the RF module 312 while the RF module 312 connects to the controller 313. The antenna 311 and the RF module 312 are used primarily for receiving identity information in the identification card. During operation, RF module continuously sends out an electromagnetic excitation signal at a fixed frequency. When an IC identification card is placed close to the identification card reader 310A, the coil in the identification card generates a weak current under the influence of the electromagnetic excitation signal. This weak current acts as a power source for the IC chip in the identification card.

It is appreciated that an IC identification card may also be read by a suitable IC card reader through direct contact instead of through RF frequency. In addition, even with the implementation using RF frequency, excitation range may be kept very small as to require an insertion of the IC identification card into a slot for the card to be excited.

The IC chip in the identification card has an encrypted version of the user identity information. Under the effect of the electromagnetic excitation signal, the chip in the identification card can send the encrypted user identity information stored in the IC chip to the identification card reader 310A. After receiving the encrypted user identity information by the antenna 311 and the RF module 312 of the identification card reader 310A, the user identity information can then be obtained by the controller 313 and then sent to the intermediary platform 202.

In one embodiment, the IC identification card reader 310A has a first cipher 371 used to decrypt the user identity information using a suitable encryption technique and a card encryption key. The merchant processing unit 320A has a second cipher 372 and a third cipher 373. The second cipher 372 is used to encrypt the bank account password using a bank encryption key. The third cipher 373 is used to encrypt the transaction amount using a transaction encryption key, which in one embodiment can be the same as the card encryption key used by the first cipher 371.

The encrypted bank account password is sent to a participating bank subsystem 203 through the intermediary platform 202, which may or may not first decrypt the bank account password for verification and then encrypt the bank account password before sending it to the participating bank subsystem 203. In general, given that the encrypted bank account password is going to be decrypted and verified by the participating bank subsystem 203, an extra layer of decryption and encryption of the bank account password by the intermediary platform 202 may not be necessary, unless there is any reason to ensure a secure transmission between the accepting device 201 (e.g., 301A in FIG. 3A) and the intermediary platform 202.

The card encryption key used in decryption of the identity information is agreed between the IC card issuer (usually a government agency) and the manufacture of the ID card reader in type I implementation or the owner of the intermediary platform in type II implementation.

The bank encryption key used by the second cipher 372 to encrypt the bank account password may be either provided by the participating bank or provided by a third party. In case where a third party bank encryption key is used, the third party also sends a corresponding decryption key to the contracted participating banks Different banks may use the same or different ciphering keys, as long as proper matching is provided in order for the issuing bank to decrypt the encrypted information received from the accepting device through the intermediary platform.

It is appreciated that the intermediary platform 202 may act as a third party between the merchant and the bank to provide such encryption and decryption keys. Bank decryption keys of each participating bank can be different or the same, as long as each participating bank can use the bank decryption key received to decrypt the bank account password.

Transaction encryption keys are agreed between the intermediary platform 202 and the merchants that use accepting devices 301A (201 in FIG. 2), and are used for secure communication between the intermediary platform and the merchants. Each transaction encryption key has a corresponding decryption key stored in the intermediary platform 202. If the transaction encryption key used by the accepting device 301A is a private key, the transaction encryption key can be used to identify the accepting device 301A. In some embodiments, a unique correspondence between the transaction encryption keys and the accepting devices 301A are used in order to ensure unique identification. In other words, each transaction encryption key corresponds to one accepting device 301A. Upon receiving encrypted information from the accepting device 301A, the intermediary platform 202 finds a decryption key corresponding to the transaction encryption key and decrypts the received encrypted information. When the transaction encryption keys are private keys, the decryption key stored in the intermediary platform 202 may be a public key used to decrypt the merchant transaction information independently encrypted by any accepting device into payment system. The intermediary platform 202 may also save the decrypted information to be used as a reference for later reconciliation among intermediary platform 202, accepting device 301A ((201 in FIG. 2) and the participating bank subsystem 203.

The participating bank subsystem 203 may be integrated with the intermediary platform 202, especially if the participating bank and the provider of the intermediary platform is the same entity or controlled by the same entity. In this case, the transaction encryption key and the bank encryption key may be the same. Accepting device 301A may use the transaction encryption key to encrypt both the bank account password and the transaction amount, and the intermediary platform 202 may use the public key to decrypt the encrypted information in order to complete the transaction.

The first cipher 371 may be embodied in a security access module (SAM) installed in the controller 313. The choice of the controller 313 may depend on the characteristics of the IC identification cards used in the payment system as different IC identification cards may require a different type of encryption. One example of the controller 313 is used for the second-generation identification cards in China. This exemplary controller 313 is provided by a limited number of venders designated by the Ministry of Security of China.

The first, second and third ciphers 371, 372 and 373 may be a software module integrated into a respective component. In the exemplary embodiment shown in FIG. 3A, for example, the first cipher 371 is a software module integrated into the controller 313 in the IC card reader 310A, while the second cipher 372 and the third cipher 373 are software modules integrated into the acceptor processor 321. The card encryption key is pre-installed in the controller 313, while transaction encryption key and the bank encryption key are installed in the acceptor processor 321.

After the first cipher 371 decrypts the user identity information using the card encryption key, the controller 313 sends the decrypted user identity information to the acceptor processor 321. The second cipher 372 of the acceptor processor 321 encrypts the bank account password using the bank encryption key. The third cipher 373 uses the transaction encryption key to encrypt the transaction amount. Subsequently, the acceptor processor 321 sends the user identity information, the encrypted bank account password and the encrypted transaction amount in a pre-established format to intermediary platform 202 through the communication unit 325.

FIG. 3B shows a schematic block representation of a second exemplary configuration of the accepting device in accordance with the present disclosure. Accepting device 301B includes IC card reader 310B and merchant processing unit 320B, and is similar to accepting device 301A except for a different configuration of the three ciphers 371, 372 and 373. In accepting device 301B, the first cipher 371 and the third cipher 373 are integrated into the controller 313 while the second cipher 372 is integrated into the acceptor processor 321. The card encryption key and the transaction encryption key are installed in the controller 313, while the bank encryption key is installed in the acceptor processor 321.

The first cipher 371 decrypts the user identification information read from the IC identification card. The controller 313 transmits the user identity information to the acceptor processor 321. Upon receiving the transaction amount entered by the merchant through input unit 323, the acceptor processor 321 transmits the transaction amount to the controller 313. The third cipher 373 in the controller 313 then encrypts the transaction amount. The controller 313 transmits the encrypted transaction amount to the acceptor processor 321. The second cipher 372 encrypts the bank account password. The acceptor processor 321 then sends the user identity information, the transaction amount and bank account password in a pre-established format to the intermediary platform 202 through the communication unit 325.

FIG. 3C shows a schematic block representation of a third exemplary configuration of the accepting device in accordance with the present disclosure. Accepting device 301C includes IC card reader 310C and merchant processing unit 320C, and is similar to accepting devices 301A and 301B except for a different configuration of the three ciphers 371, 372 and 373. In accepting device 301C, the first cipher 371, the second cipher 372 and the third cipher 373 are all integrated into the controller 313 of the IC card reader 310C. The card encryption key, the bank encryption key and the transaction encryption key are all installed in the controller 313.

The first cipher 371 decrypts the user identification information read from the IC identification card. The controller 313 transmits the user identity information to the acceptor processor 321. Upon receiving from input unit 323 the information such as the bank account password entered by the user and the transaction amount entered by the merchant, the acceptor processor 321 sends this information to the controller 313 for encryption. After encryption, the encrypted information is returned to the acceptor processor 321, which sends the encrypted information along with the user identity information to the intermediary platform 202 through the communication unit 325.

FIG. 3D shows a schematic block representation of a fourth exemplary configuration of the accepting device in accordance with the present disclosure. Accepting device 301D includes IC card reader 310D and merchant processing unit 320D, and is different from accepting devices 301A, 301B and 301C in the cipher configuration. Accepting device 301D does not have a first cipher 371 to decrypt identification information read from IC identification card reader 310D. This configuration is suitable for type II implementation of FIG. 2B in which the intermediary platform 202B is equipped with a cipher assembly 270 to decipher the identification information. For example, accepting device 301D may be used in place of accepting device 201B in payment system 200B of FIG. 2.

In operation, the IC card reader 310D reads the encrypted identification information from an IC card and sends the identification information to the merchant processing unit 320D, which then sends the identification information to the intermediary platform 202B to be decrypted.

Accepting device 301D still has the second cipher 372 and the third cipher 373. In one embodiment the second cipher 372 and the third cipher 373 are integrated into the acceptor processor 321 of the merchant processing unit 320D. The bank encryption key and the transaction encryption key are all installed in the acceptor processor 321.

Upon receiving from input unit 323 the information such as a bank account password entered by the user and a transaction amount entered by the merchant, the second cipher 372 and the third cipher 373 encrypt the information entered by the user. For example, the second cipher 372 encrypts the bank account password using a bank encryption key provided by a corresponding issuing bank or a third party. The third cipher 373 encrypts the merchant transaction information using a transaction encryption key. After encryption, the acceptor processor 321 sends the encrypted information along with the user identity information to the intermediary platform 202 through the communication unit 325. The operation of the second cipher 372 and the third cipher 373 is similar to that described in the context of accepting device 301A of FIG. 3A, and is therefore not repeated here.

The detail of the intermediary platform 202B equipped to decrypt identification information will be described in a later section of this description.

It is appreciated that other alternate configurations of the second cipher 372 and the third cipher 373 may be used. For example, the second cipher 372 and the third cipher 373 may be implemented as separate unit(s) instead of being integrated with the acceptor processor 321. At least one of the second cipher 372 and the third cipher 373 may also be implemented in the IC identification card reader 310D (e.g., integrated with the card reader controller 313).

FIG. 3E shows a schematic block representation of a fifth exemplary configuration of the accepting device in accordance with the present disclosure. Accepting device 301E includes IC card reader 310E and merchant processing unit 320E. In comparison to other accepting devices 301A, 301B, 301C and 301D, accepting device 301 has a ciphering unit 370 which is a separate unit instead of being integrated with the acceptor processor 321. The ciphering unit 370 may have one or more ciphers.

In one embodiment, accepting device 301E does not have first cipher 371 to decrypt identification information read from IC identification card reader 310D. This configuration is similar to accepting device 301D and is suitable for type II implementation of FIG. 2B in which the intermediary platform 202B is equipped with a cipher assembly 270 to decipher the identification information. For example, accepting device 301E may used in place of accepting device 201B in payment system 200B of FIG. 2.

In exemplary configurations described above, the input unit 323 is used to receive information entered externally. Examples of externally entered information are a transaction amount entered by merchant, a bank account password entered by the user, and a combination of a bank account password entered by the user and information of a participating bank chosen by the user. The input unit 323 can be any input device such as a keyboard or a touch screen. Under normal conditions, the input unit 323 receives bank account password entered by user, information of participating bank and transaction amount entered by merchant. A bank encryption key corresponding to the participating bank is used to encrypt the bank account password entered by the user.

The output unit 324 is used to output a result of the transaction. The output unit 324 can be any output device such as a display or a printer. The output unit 324 is used to output (e.g., displaying on a screen or printing out through a printer) the result of the payment transaction so that the merchant and the user can determine whether the transaction is successful based on whether a bank account deduction has been successfully made. If the transaction is not successful, the output unit 324 may output the reasons that may have caused the transaction to be unsuccessful. In addition, the output unit 324 can print out the transaction result as evidence or documentation for the transaction completed.

The acceptor processor 321 connects to the input unit 323, the output unit 324 and the controller 223. The acceptor processor 321 is used to control different operations of the merchant in the transaction. Examples of such operations include transmitting information from the input unit 323 to the cipher 371, transmitting the information decrypted by the cipher 371 to the communication unit 325, and transmitting a processing result (such as a bank transaction result) returned from the communication unit 325 to the output unit 324. The acceptor processor 321 can be made from an existing Programmable Logic Device (PLD). For instance, the processor can use a single-chip microprocessor such as series 51 (89S52, 80052, 8752, etc.) or any other suitable microprocessor.

The acceptor processor 321 may receive information such as user identity information and name of the user from the identification card reader (310A, 310B, 310C, 310D or 310E) and display this information through the output unit 324. As the identification card reader reads an identification card, it may reject the identification card if no machine-readable information or machine-readable image can be displayed. This happens usually because the identification card does not have properly encrypted information (which is likely to indicate a forged identification card), or the card is damaged. In this case, the transaction may be denied. Moreover, a representative of the merchant (e.g., a cashier) using the identification card reader to read the identity information may compare the photo of the customer (the user) displayed in the identification card reader. If the photo and the physical appearance of the customer do not match (that is, the machine-readable information is not like the visual manifestation of the user seen by the representative), the representative of the merchant may conclude that the identification card does not belong to this customer and deny the transaction.

The acceptor processor 321 may receive and execute commands entered externally to complete corresponding tasks. Examples of external commands are outputting contents read by the identification card reader to another external equipment, and updating locally stored bank encryption key when receiving an updated bank encryption key of a participating bank.

The disclosed payment system may use an API interface installed on the accepting device 201 to accomplish high expandability and compatibility of the accepting device. For example, the acceptor processor 321 may have an API interface to establish connection between accepting device 201 (which can be any of 310A, 310B, 310C, 310D or 310E of FIG. 3) and intermediary platform 202. This includes communicating user identity information as well as entered transaction amount between accepting device 201 and the intermediary platform 202. The API interface on the accepting device may also carry out other procedures. Through the API interface, the accepting device 201 can establish a seamless connection with the intermediary platform 202. Connection between accepting device 201 and other external equipment can also be established through this API interface.

The communication unit 325 is used to establish the interaction with the intermediary platform. The communication unit 325 sends the encrypted information to the intermediary platform 202 and transmits the processing result from the intermediary platform 202 to the acceptor processor 321. The communication unit 325 may have a designated interface that supports network connection through a regular phone, a dial-up modem of any network or LAN. The communication unit 325 is primarily used for establishing connection between accepting device and intermediary platform 202. For example, the communication unit 325 on the accepting device may match a communication unit of the intermediary platform 202 to support communication through a modem of different dial-ups such as regular phone, GPRS and CDMA, and other designated communication ports.

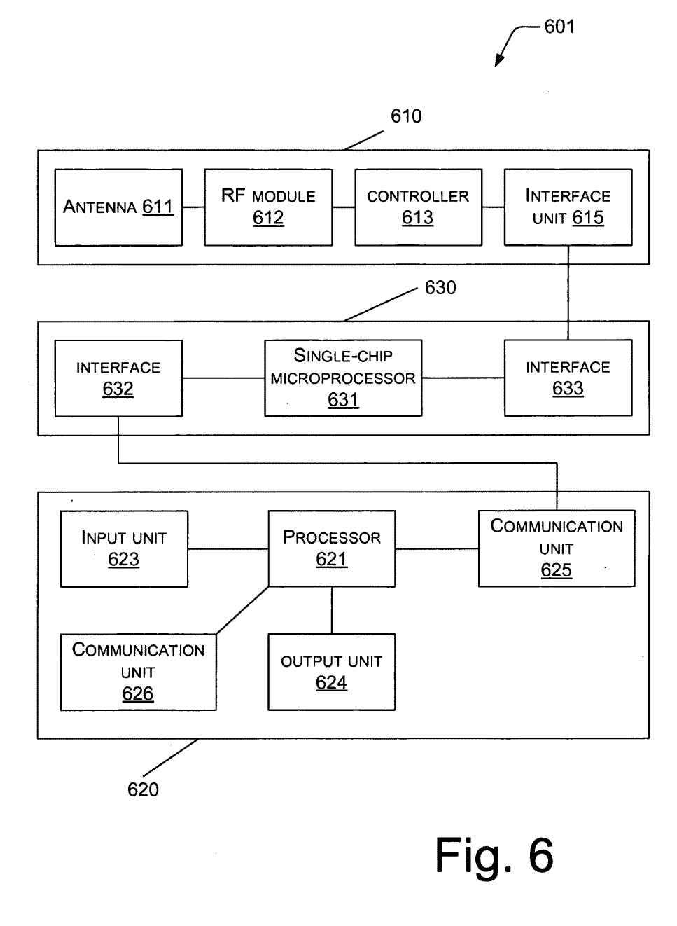

The ciphers in this disclosure may be single-chip microprocessor(s), such as single-chip MCS, and maybe further embodied in a separate component rather than be integrated into the controller 313 or the acceptor processor 321, as will be described with reference to FIG. 6.

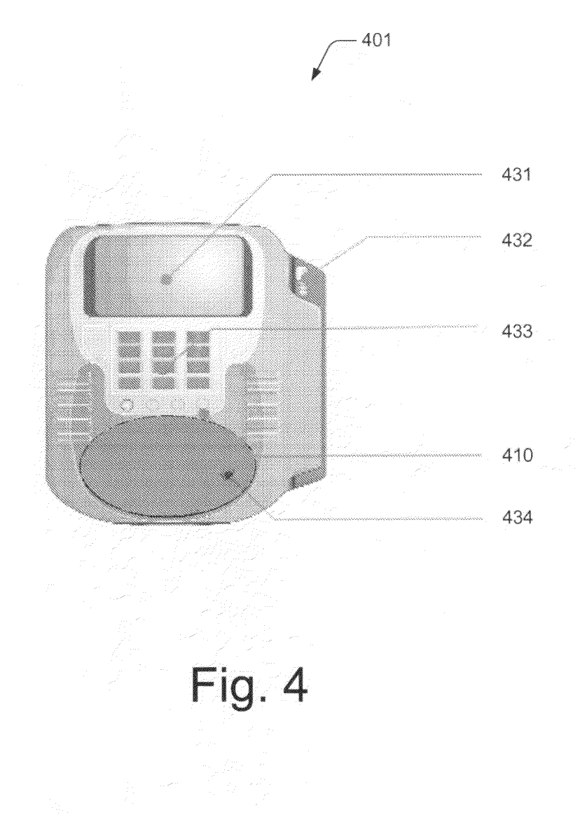

FIG. 4 is a schematic diagram of an exemplary accepting device in accordance with the present disclosure. The accepting device 401 should be understood with reference to other figures of the present description, such as FIGS. 2, 3, 5 and 6. The accepting device 401 has a box shape and includes a casing and internal structure. A display screen 431 is a part of an output unit (324) and is installed on the upper front side of the casing and is used for displaying information. For example, when an IC identification card is read, information in the IC identification card will be displayed on the display screen 431. Below the display screen 431 is a keyboard 433 which is part of an input unit (323) for entering information by user or merchant. Further below the keyboard 433 is installed an identification card reader 410. When the IC identification card is placed in reading zone 434, the information on the IC identification card is read by the identification card reader 410. Reading the IC identification card can be completed without direct contact between the IC identification card and the identification card reader 410. The identification card reader 410 continuously sends out an electromagnetic excitation signal through its coil. When an identification card is placed in the reading zone 434 of the card reader, the coil in the identification card will generate a weak current under the influence of the electromagnetic excitation signal. This current acts as a power source for the IC chip in the IC identification card. The chip contains user identity information. The IC chip of the identification card sends the user identity information to the identification card reader 410 to complete the reading operation with the effect of the electromagnetic excitation signal.

In type I implementation where the accepting device 401 has ability to decrypt user identification information, the identification card reader 410 sends the encrypted user identity information to a cipher (371) to be decrypted. The decrypted user identification information is sent to a processor (321) installed in the internal structure of the accepting device 401. The processor (321) sends the received information to the display screen 431 for display.

In type II implementation where the accepting device 401 has no ability to decrypt user identification information, the identification card reader 410 sends the encrypted user identification information to the processor (321) to be communicated to the intermediary platform to be decrypted. The intermediary platform may return the decrypted user identification information to the accepting device 401 to be displayed on the display screen 431. It is appreciated that the displaying of the decrypted user identification information on the accepting device 401 is optional. The IC identification card may bear non-encrypted identification information, such as a printed photo of the cardholder, which can be used for the purpose of verification by the merchant.

The processor (321) also may also send a request message for the user to enter a bank account password and a request message for the merchant to enter a transaction amount. The request message is may be sent to the display screen to be displayed. This prompts the user to enter the bank account password and the merchant to enter the transaction amount.

The processor (321) receives the bank account password entered by the user and transaction amount entered by the merchant through the keyword 433. Upon encrypting the bank account password and the transaction amount using ciphers, the processor (321) transmits this encrypted information along with user identification information (decrypted in type I implementation for encrypted in type II implementation) to a communication unit (325). In this exemplary embodiment, the communication unit may use a special designated port 432 that connects to an opposite end through LAN.

The identification card reader 410 of the accepting device 401 can be provided by designated vendors. In type II implementation, because there is no need to have the ability to decrypt user identification information by the identification card reader 410 or the accepting device 401, there may be more design freedom and lower cost for manufacturing the accepting device 401 with the identification card reader 410.

The user identification information, transaction amount and the bank account password may be encrypted before they are sent out in order to ensure the security of the data. Especially, in an embodiment where the ciphers (371, 372 and 373) are integrated into the controller (313) of the IC card reader 310, the merchant cannot modify the information in the controller. The safety of the encrypted information is thus further enhanced in this configuration. In type II implementation, because the user identification information may be kept encrypted while in the accepting device 401, there is less opportunity for preaching of privacy on the merchant side.

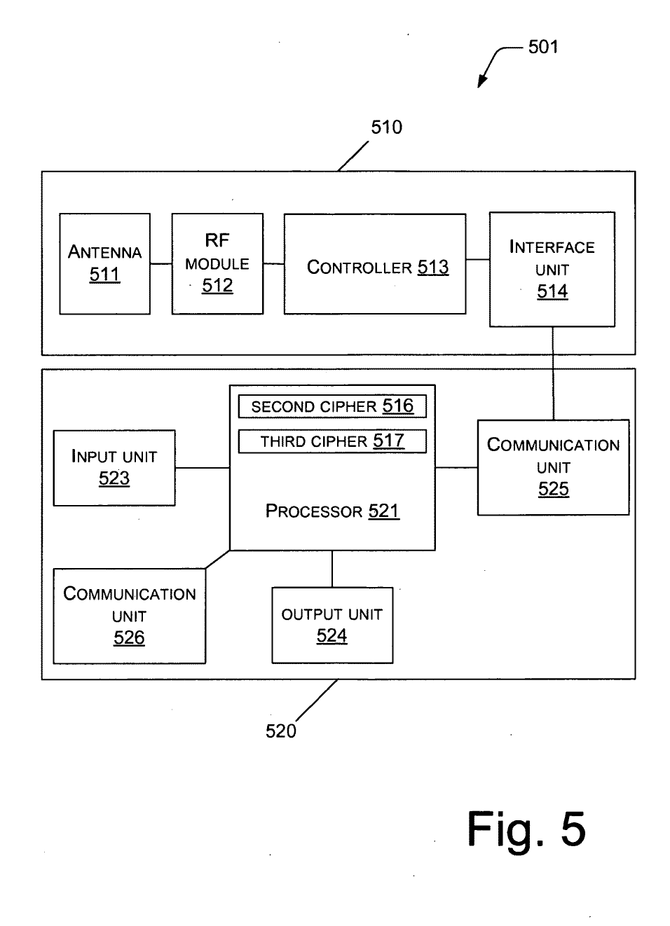

FIG. 5 shows a schematic block representations of an exemplary accepting device using a computer interfacing with an IC card reader. The accepting device 501 should be understood with reference to the payment system 200 of FIG. 2 by substituting one of the accepting devices 201 in FIG. 2 with the accepting device 501.

Accepting device 501 has an identification card reader 510 and a computing terminal 520. Accepting device 501 is similar to accepting device 301D. In fact, accepting device 501 may be understood as a special case of accepting device 301D in which the processing unit 320D is implemented with a computer terminal 520. The identification card reader 510 includes an antenna 511, a RF module 512, a controller 513 and an interface unit 514. The interface unit 514 is designed to interface with the computer terminal 520. The RF module 512 separately connects to the antenna 511 and the controller 513, while the controller 513 connects to the interface unit 514. The identification card reader 510 is used to read user identity information on a user identification card.

Two ciphers, a second cipher 516 and a third cipher 517 are used for encryption and decryption. The second cipher 516 is used to encrypt a bank account password using a bank encryption key either provided by a participating bank or provided by a third party. The third cipher 517 is used to encrypt transaction amount using the transaction encryption key.

The computing terminal 520 connects to the identification card reader 510 and includes an input unit 523, an output unit 524, a processor 521 and two communication units 525 and 526. The communication unit 525 connects to the identification card reader 510 through interface unit 514, while the communication unit 526 connects to the intermediary platform (202).

The input unit 523 is used to receive information entered externally. Examples of externally entered information are a transaction amount entered by merchant, a bank account password entered by user, and a combination of a user-entered bank account password and information of a participating bank chosen by user. The output unit 524 (typically a computer screen) is used to output a transaction result.

The processor 521 connects to the input unit 523, the output unit 524 and the communication units 525 and 526. The processor 521 sends the user identification information, encrypted bank account information and the encrypted merchant transaction information to communication unit 526 to be transmitted to the intermediary platform (202), to receive a bank transaction result returned from the participating bank subsystem (203) through the intermediary platform (202) and the communication unit 526, and to send the received bank transaction result to the output unit 524.

The communication units 525 and 526 connect to the processor 521 and are used to establish interaction with other equipment. The communication unit 525 connects to the identification card reader 510, and can use a port matching the interface unit 514 in the identification card reader 510. One example of such matching ports is USB ports. The communication unit 526 connects to the intermediary platform (202), and may be a designated interface that supports network connection through regular phone, a dial-up modem of any network or LAN to opposite ends.

In the accepting device 501A, 501B or 501C, the identification card reader 510 and the computing terminal 520 may be two individual components connected to each other. The identification card reader 510 can be modular and designed to work with any computing terminal that meets the interface requirements to complete a payment request.

FIG. 6 is a schematic block representation of an exemplary accepting device having a separate ciphering unit. Accepting device 601 has an identification card reader 610, a ciphering unit 630 and a computing terminal 620.

The identification card reader 610 has an antenna 611, a RF module 612, a controller 613 and an interface unit 615. The RF module 612 connects to the antenna 611 and the controller 613, which in turn connects to the interface unit 615. The identification card reader 610 is used to read user identity information (such as a user identification card number) on a user identification card.

The ciphering unit 630 is a separate unit connected to but not integrated with the identification card reader 610 and the computing terminal 620. The ciphering unit 630 has a single-chip microprocessor 631 and two interfaces 632 and 633. The single-chip microprocessor 631 connects to each interface 632 and 633. The two interfaces 632 and 633 connect to the computing terminal 620 and the identification card reader 610, respectively.

In principle, the ciphering unit 630 may be designed to perform all necessary encryption and decryption on the merchant side, including the decryption of user identification information read from an IC identification card and the encryption of the bank account information and merchant transaction information. In one embodiment, the ciphering unit 630 performs the encryption of the bank account information and merchant transaction information only and does not perform decryption of the user identification information. This embodiment is suited for type II implementation of the payment system as discussed above.

For example, in one embodiment the single-chip microprocessor 631 is used to encrypt transaction amount a transaction encryption key and to encrypt a bank account password using a bank encryption key provided by either a participating bank or a third party.

The computing terminal 620 has an input unit 623, an output unit 624, a processor 621 and communication units 625 and 626, performing similar functions as that of the computing terminal 520. In addition, the computing terminal 620 may also interact with the identification card reader 610 directly, either through the same communication unit 626 or via another communication unit (not shown) installed in computing terminal 620.

The communication unit 626 which connects to the intermediary platform may be a special designated interface that supports network connection through regular phone, a dial-up modem of any network or LAN to opposite ends. The communication unit 625 which interacts with the ciphering unit 630 and the identification card reader 610 can be a USB port or any other suitable port that can establish such communication. The single-chip microprocessor 631 of the cipher unit 630 may be an MCS51 model or a single-chip microprocessor of another type or model.

The above description only provides a few exemplary embodiments of accepting device 201 in accordance with this disclosure. The accepting device 201 may be embodied in a container of sufficient room as shown in FIG. 4 having installed therein all components (such as that shown in FIGS. 3, 5 and 6). Alternatively, the accepting device may be made up of two individual components. For example, the input unit, the output unit, the processor, the ciphers and the communication units of FIG. 5 are integrated in computing terminal 520, while the identification card reader 510 is embodied as another component. The identification card reader 510 and the computing terminal 520 are interconnected with each other through their respective interfaces. Alternatively, the accepting device may also be made up of three individual components. For instance, as in FIG. 6, the input unit, the output unit, the processor and the communication units are integrated in computing terminal 620. The ciphering unit 630 and the identification card reader 610 are each embodied as an individual component. The cipher unit 630 and the computing terminal 620 are interconnected with each other through their respective interfaces whereas the cipher unit 630 and the identification card reader 610 are interconnected with each other through their interfaces.

In addition, the accepting device may also have an API interface used to establish connection between a merchant and the intermediary platform. The functions performed through the API interface include obtaining user identity information as well as transaction amount entered from the accepting device. The API interface on the accepting device may also carry out other functions. Through the API interface, the accepting device can establish a seamless connection with the intermediary platform. Connection between accepting device and other external equipment can also be established through this API interface. The API interface may be preinstalled in the accepting device to realize high expandability and compatibility.

In connection to the accepting device disclosed above, intermediary platform 202 and participating bank subsystem 203 in this disclosure are described as follows.

Referring back to FIGS. 2, 2A and 2B, the intermediary platform (202, 202A or 202B) is primarily used to establish transaction between merchant and participating banks An example of the intermediary platform (202, 202A or 202B) is Alipay platform of Alibaba Group Holding Ltd. User may first activate on the intermediary platform the payment method which uses an identification card. This can be done by opening an account and registering user identification information at the intermediary platform. A participating bank of the participating bank subsystem 203 can sign a contract with the intermediary platform to provide information such as user account information and encryption and decryption keys. During a payment transaction, a user who has a bank account with the participating bank only needs to select or provide the name of the bank and enter a bank account password at an accepting device to complete operations such as a payment and credit card pre-authorization.

### Intermediary Platform

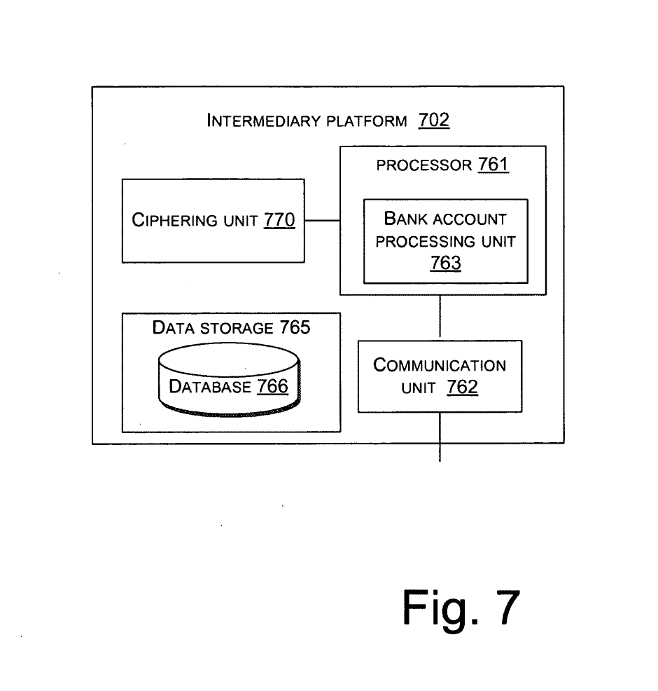

FIG. 7 shows further detail of an intermediary platform of the present payment system. The intermediary platform 702 has a platform processor 761 including a bank account processing unit 763, a communication interface 762 and a ciphering unit 770. The ciphering unit 770 is used to decrypt the encrypted information sent from the accepting device 201.

The platform processor 761 receives data from an accepting device (e.g., 201, 201A or 201B) and resolves the data into various kinds, such as user identification information, bank account information, billing information, transaction amount. Depending on the configuration of accepting device, such information may be encrypted, decrypted or non-encrypted. In type II implementation of FIG. 2B, for example, the user identification information received from the accepting device 201B is encrypted. The platform processor 761 sends the received encrypted user identification information to decryption chip assembly 773 to be decrypted.

In the following, the intermediary platform 702 is described assuming a type II implementation where the intermediary platform has the ability to decrypt user identification information. However, other than the decryption of user identification information, most of the description below applies to type I implementation as well.

The data storage 765 of intermediary platform 702 has stored thereupon decryption keys such as the IC identification card decryption keys and transaction decryption keys corresponding to the transaction encryption keys of each contracted accepting device 201. If decryption of bank information (such as bank account password) is done at intermediary platform 702 by ciphering unit 770, data storage 765 may also store bank description keys. Alternatively, the description keys may be stored in a memory contained in the ciphering unit 770.

The ciphering unit 772 decrypts the user identification information is inappropriate to encryption algorithm and an IC card decryption key. An exemplary embodiment of the ciphering unit 770 is a decryption chip assembly 270 of FIG. 2B. The decryption chip assembly 270 is for type II implementation in which the intermediary platform 202B performs the decryption of the identification information sent from accepting device 201B which may not have its own decrypting equipment to decrypt the identification information. The decryption chip assembly 270 may have one or more decryption chips which are manufactured by the standard and requirement imposed by the IC identification card issuer, usually a government agency (e.g., Ministry of Public Security in China). Each decryption chip in the decryption chip assembly 270 is manufactured to have the decryption ability using a decryption algorithm that matches the encryption algorithm used to encrypt the IC identification cards. The decryption chips in the decryption chip assembly 270 may be manufactured by the same government-designated manufacturers that make the IC identification cards. Alternatively, these manufactures may collaborate with the owner of the intermediary platform by providing a matching decryption algorithm.

When used as a decipher of user identification information, multiple decryption chips operating in parallel are preferred in the ciphering unit 770 in order to better handle a large number of decryption requests sent from multiple accepting devices. In one embodiment, the ciphering unit 770 is embodied in a server for a large capacity of parallel processing. In another embodiment, the ciphering unit 770 has a ciphering module (e.g. a software module) integrated with the platform processor 761.

Upon receiving the encrypted merchant transaction information, the intermediary platform 702 finds the corresponding decryption key to decrypt the encrypted information. The merchant transaction information typically includes a transaction amount. The intermediary platform 702 saves the encryption key, the user identity information and the transaction amount after decryption. When the participating bank subsystem 203 returns a bank transaction result on whether the bank transaction (e.g., a deduction from the user's bank account) is successful, the intermediary platform 702 also saves the received bank transaction result. The intermediary platform 702 may use this saved information to perform reconciliation with the merchant and the participating bank in the future. The transaction encryption key can be a private key and the corresponding transaction decryption key a public key. With a private transaction encryption key, the intermediary platform 702 may readily verify the identity of the accepting device and the associated merchant conducting the transaction.

The platform processor 761 further includes a bank account processing unit 763 interacting with database 766. The database 766 contains a mapping relationship between the user identification card numbers and user bank accounts. Before carrying out the transaction, user can first register with the intermediary platform 702 a bank account number that corresponds to the user identification card number. If a user identification card number corresponds to only one bank account number with a particular participating bank, such registration may not be necessary. But if multiple bank account numbers correspond to the same identification card number in the participating bank chosen by user for the payment, the user usually needs to either set up a unique bank account number in the intermediary platform 702, or make a unique selection of a paying bank at the accepting device 201 during the payment transaction.

After the platform processor 761 has decrypted the encrypted information from the accepting device 201, the platform processor 761 uses the user identification card number to search for a corresponding bank account in the database 766. If a corresponding bank account is found, the platform processor 761 sends the bank account number as part of the bank transaction information to the participating bank subsystem 203. The intermediary platform 702 and the participating bank 203 may have a pre-agreed data structure for transmission. The data structure may contain a field for bank account number. The bank account number found can be placed in the respective field to facilitate identifying and reading the bank account number by the participating bank subsystem 203.

The platform processor 761 saves the decrypted information in data storage 765 and sends bank transaction information (which may include both decrypted information and encrypted information) to the participating bank subsystem (e.g., 203). The platform processor 761 also sends a bank transaction result returned from the participating bank subsystem to the accepting device after storing the bank transaction result.

The communication interface 762 establishes communication with the accepting device (e.g., 201B) and the participating bank subsystem (e.g., 203).

In case where the bank transaction information sent from the intermediary platform 702 does not contain a bank account number, the participating bank subsystem may look up the bank account number corresponding to the user identification number in its own database and verify the decrypted bank account password. Upon verifying the decrypted bank account password, the participating bank subsystem processes the transaction and returns a bank transaction result.

The participating bank subsystem usually has a bank processor and a bank database. The bank database stores bank account information which includes information of the account holder of a bank account, bank account number, bank account password and balance. The bank processor may have a data reading module, a decryption module and a transaction processing module. The data reading module is used to read a transaction request from the intermediary platform 702 and parse out information such as user identity information, encrypted bank account password and other bank account information from the transaction request. The decryption module decrypts the encrypted bank account password to obtain the bank account password.

When the bank transaction information contains a bank account information (e.g., a bank account number), the transaction processing module identifies the bank account by the bank account information, and compares the decrypted bank account password with the bank account password stored in the bank database. If the passwords are found matching, verification is successful and the transaction processing module then processes a debit transaction. If the passwords are found different, authentication fails. If the bank transaction information does not contain bank account information, the transaction processing module may find a bank account according to the user identification card number in the bank database. If more than one bank account number is found to correspond to the same identification card number in the participating bank, the participating bank subsystem may either terminate the payment transaction or send a message to the intermediary platform to request the user to provide a specific bank account number for this payment.

In one embodiment of intermediary platform 702, the ciphering unit 770 further encrypts the bank transaction information using a previously stored encryption key before sending the information to the participating bank subsystem. The previously stored encryption key is an encryption key agreed with the participating bank. Accordingly, the participating bank subsystem may have a ciphering unit to decrypt the bank transaction information received using a corresponding decryption key. The participating bank subsystem may also encrypt the bank transaction result before sending the result to intermediary platform 702. The ciphering unit 770 decrypts the bank transaction result received from the participating bank subsystem 203 using a previously stored decryption key. The previously stored decryption key is usually agreed (and may be provided) by the participating bank.

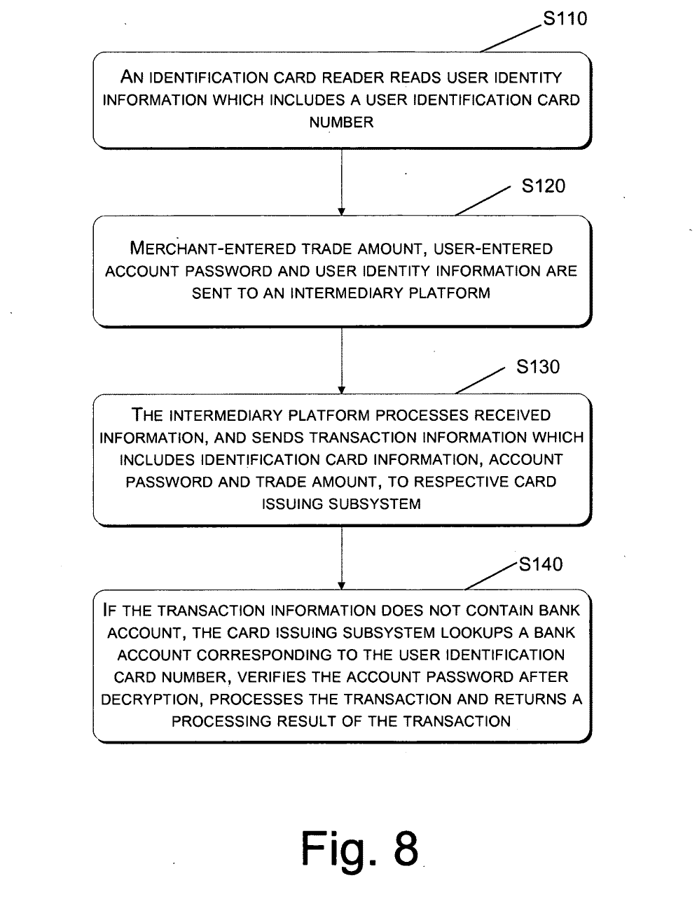

FIG. 8 is a flow chart of an exemplary process of the payment method using an IC identification card in accordance with the present description. In this description, the order in which a process is described is not intended to be construed as a limitation, and any number of the described process blocks may be combined in any order to implement the method, or an alternate method. The major blocks of the exemplary process is described as follows.

At S110, an identification card reader of an accepting device reads user identity information which includes a user identification card number from an IC identification card presented by a cardholder (a customer). With a type I implementation described above, as the user identification information is read by the identification card reader, a cipher of the identification card reader decrypts the user identification information. With a type II implementation described above, the encrypted user identification information is sent to an intermediary platform to be encrypted.

Under certain situations, the accepting device may need to display user identity information so that merchant can compare the information of card holder with that of the customer. To do this, the accepting device sends the user identity information to a processor contained therein, which displays the information through an output unit. If the merchant determines that the identity information of the customer does not match the manifestation of the cardholder, the merchant may deny the payment. Additionally or alternatively, the merchant may visually verify the identity of the cardholder using a printed photo on the IC authentication card.

The accepting device also receives user bank account information (such as a bank account password) and merchant transaction information (such as a transaction amount). For example, the user enters a bank account password and a respective bank name as prompted at the output unit. The merchant enters a transaction amount as prompted at the output unit. Upon receiving the bank account password entered through an input unit, the accepting device encrypts the bank account password using a bank encryption key which is either provided by the participating bank or provided by a third party. Upon receiving the transaction amount entered through the input unit, the accepting device encrypts the entered transaction amount using a transaction encryption key.

At S120, a transaction amount entered by merchant and a bank account password entered by user are encrypted and sent to the intermediary platform. The user identification information is also sent to the intermediary platform. In type I implementation, the user identification information is first decrypted before sent to the intermediary platform. In type II implementation, the encrypted user identification information is passed to the intermediary platform to be decrypted.

At S130, the intermediary platform processes the received user identification information, bank account information, and merchant transaction information. To process the information, the intermediary platform may decrypt part of the encrypted information received. In type I implementation, the intermediary platform may decrypt the encrypted bank account information and merchant transaction information. In type II implementation, the intermediary platform may decrypt the encrypted user identity information, the bank account information and the merchant transaction information. In one embodiment, intermediary platform uses a bank decryption key corresponding to the bank encryption key to decrypt the bank account information, users a transaction decryption key corresponding to the transaction encryption key to decrypt the merchant transaction information, and stores the decrypted information. In another embodiment, intermediary platform does not decrypt the bank account information but instead passes it to the participating bank subsystem to be decrypted.

The intermediary platform then transmits bank transaction information (which includes the identification information, the bank account password and the transaction amount) to a respective participating bank subsystem.

At S140, if the bank transaction information does not contain the bank account number, the participating bank subsystem looks up the bank account number corresponding to the user identification number and verifies the decrypted bank account password. Upon verifying the decrypted bank account password, the participating bank subsystem processes the transaction and returns a bank transaction result. Furthermore, if the participating bank subsystem finds more than one bank account number corresponding to the same identification card number in the participating bank, the participating bank subsystem may either terminate the payment transaction or send a message to the intermediary platform to request the user to provide a specific bank account number for this payment.

In one embodiment, the user bank account may be identified by the intermediary platform. In this case, the process may further include the following acts:
(1) pre-storing at the intermediary platform a mapping relationship between user identification card numbers and user bank accounts; and (2) looking up the bank account number corresponding to the user identification card number from the mapping relationship, and if found, sending the bank account number as part of the bank transaction information to the participating bank subsystem.

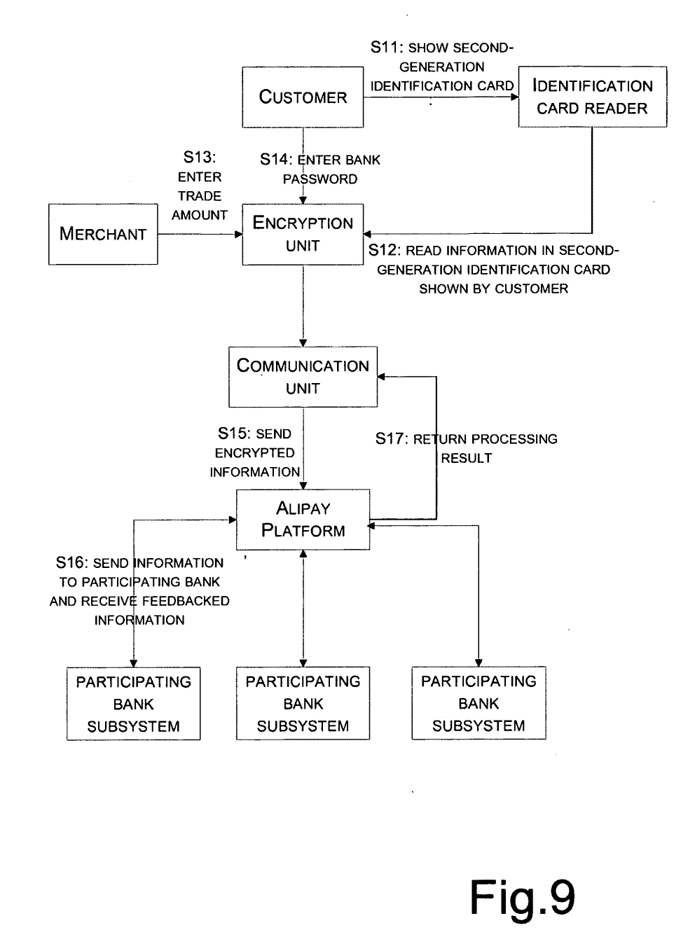

FIG. 9 illustrates an exemplary process of the payment method using Alipay payment platform as the intermediary platform. The exemplary process is described as follows.

At S11, an identification card reader receives an IC identification card provided by a customer.

A S12, the identification card reader transmits identification information read from the IC identification card to an acceptor processor.

At S13, a merchant enters an amount of current transaction through an input unit.

At S14, the customer selects or enters the name of a bank paying for the transaction and a respective bank account password through the input unit.

The processor uses a bank encryption key (which corresponds to a participating bank and may be provided by the bank and stored locally in advance) to encrypt the bank account password. The processor also uses a transaction encryption key stored in advance to encrypt the transaction amount.

At S15, the processor sends the identification information along with the other encrypted information to Alipay payment platform through a communication unit.

At S16, Alipay payment platform decrypts the received information. With a type II implementation, for example, the Alipay payment platform has a decryption chip assembly (either implemented in a separate server or integrated with a platform processor) to perform parallel decryption of the user identification information received from multiple accepting devices. The Alipay payment platform may further decrypt the encrypted the bank account information and the merchant transaction information.

If the received information contains information of the bank selected by user, Alipay sends bank transaction information such as user identity information and transaction amount to the participating bank subsystem of the selected bank for processing. If the received information does not contain participating bank information (e.g., the name of a bank), Alipay may send bank transaction requests to multiple participating banks to identify a participating bank can match the user identification and successfully process the bank transaction. The bank transaction request may be sent to the banks one by one until a matching participating bank has been identified. One example of the bank transaction request is a request for a deduction from a user bank account to make a payment. If the requested bank transaction cannot be successfully processed by any of the participating banks, Alipay payment platform may return a bank transaction result indicating a failed transaction.

At S17, Alipay sends the bank transaction result (e.g., the result of a bank account deduction request) returned by the participating bank to the respective processor of the merchant. Depending on the bank transaction result received, the processor determines whether the transaction can continue.

The bank transaction result may be sent through Alipay payment platform. Alternatively, bank transaction result may be sent to the merchant and the user directly by the participating bank.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A payment system for trading using an IC identification card, the system comprising:
an accepting device having an IC identification card reader to receive an encrypted user identity information from an IC identification card, the accepting device being adapted for further receiving a user bank account information; and
an intermediary platform adapted for
receiving the encrypted user identity information and the user bank account information sent from the accepting device,
decrypting a first encrypted information including at least the encrypted user identity information,
communicating a bank transaction information including the decrypted user identity information and the user bank account information to a participating bank subsystem to request a bank transaction,
receiving a bank transaction result from the participating bank subsystem, and
communicating the bank transaction result to the accepting device.

2. The payment system as recited in claim 1, wherein the accepting device is adapted for encrypting the user bank account information and sending the encrypted user bank account information to the intermediary platform.

3. The payment system as recited in claim 2, wherein the intermediary platform is adapted for decrypting the encrypted user bank account information.

4. The payment system as recited in claim 1, wherein the accepting device further has an input unit separate from the IC identification card reader for receiving the user bank account information.

5. The payment system as recited in claim 4, wherein the input unit is used for further receiving merchant transaction information including a transaction amount.

6. The payment system as recited in claim 1, wherein the user bank account information received by the accepting device includes a bank account password entered by the user.

7. The payment system as recited in claim 1, wherein the user bank account information received by the accepting device includes information of the participating bank chosen by the user and a bank account password entered by the user.

8. The payment system as recited in claim 1, wherein the user bank account information sent to the participating bank includes a bank account number of the user with the participating bank.

9. The payment system as recited in claim 1, wherein if the user bank account information sent to the participating bank does not include a bank account number of the user with the participating bank, the payment system is configured to expect the participating bank subsystem to lookup a bank account number corresponding to the user identification card number and verify the user bank account information including a bank account password.

10. The payment system as recited in claim 1, wherein the accepting device has a cipher for encrypting the user bank account information using a bank encryption key provided by either the participating bank or a third party.

11. The payment system as recited in claim 1, wherein the accepting device has a cipher for encrypting a transaction amount received by the accepting device.

12. The payment system as recited in claim 1, wherein the accepting device further includes:
a first cipher used for encrypting the user bank account information using a bank encryption key provided by either the participating bank or a third party; and
a second cipher used for encrypting a transaction amount received by the accept device.

13. The payment system as recited in claim 12, wherein the first cipher and the second cipher are integral parts of a processing unit connected to the identification card reader.

14. The payment system as recited in claim 12, wherein at least one of the first cipher and the second cipher is an integral part of the identification card reader.

15. The payment system as recited in claim 12, wherein the first and the second ciphers are each a software module.

16. The payment system as recited in claim 12, wherein at least one of the first cipher and the second cipher is ciphering unit separate from the identification card reader.

17. The payment system as recited in claim 1, wherein the accepting device comprises a merchant processing unit connected to the identity card reader, the merchant processing unit including:
an input unit used for receiving external information entered outside of the identification card reader, the external information including at least one of a trade amount entered by a merchant, a bank account password entered by the user, and information of a participating bank chosen by the user;
an output unit used for outputting a transaction result;
a processor used for processing the external information received from by input unit and/or the encrypted user identification information received by the IC identification card reader; and
a communication unit used for communicating process information to the intermediary platform.

18. The payment system as recited in claim 17, wherein the merchant processing unit is implemented in a computing device interfacing with the identification card reader, and wherein the output unit includes a display screen.

19. The payment system as recited in claim 1, wherein the intermediary platform further comprises:
a database storage unit storing a mapping relationship between a plurality of bank account numbers and a plurality of user identification card numbers; and
a bank account processing unit for looking up a bank account number corresponding to the identification card number from the mapping relationship, and including the bank account number in the bank transaction information to be communicated to the participating bank subsystem.

20. The payment system as recited in claim 1, wherein the intermediary platform is further adapted for:
encrypting the bank transaction information using an encryption key agreed by the participating bank before sending the bank transaction information to the participating bank subsystem; and
decrypting the bank transaction result communicated from the participating bank subsystem using a decryption key agreed by the participating bank.

21. The payment system as recited in claim 1, wherein the accepting device has an API interface interfacing between a merchant and the intermediary platform.

22. The payment system as recited in claim 1, wherein the accepting device has a communication unit supporting connection through a regular phone line, a dial-up modem of any network or a LAN.

23. A payment system for trading using an IC identification card, the system comprising:
an accepting device having an identification card reader and a first processor,
the accepting device being adapted to:
receive through the identification card reader an encrypted user identification information from an IC identification card,
receive a user bank account information including a bank account password, and
send the encrypted user identification information and the user bank account password using the first processor; and
an intermediary platform having an encryption device and a second processor, wherein the encryption device is used for decrypting at least the encrypted user identification information sent from the accepting device, and the second processor is used for determining a bank account number corresponding to the user identification information, the intermediary platform being further adapted to:
communicate a bank transaction information including the bank account number and the user bank account password to a participating bank subsystem to request a bank transaction,
receive a bank transaction result from the participating bank subsystem, and
communicate the bank transaction result to the accepting device.

24. The payment system as recited in claim 23, wherein the second processor determines the bank account number using a mapping relationship between a plurality of bank account numbers and a plurality of user identification card numbers, the mapping relationship being stored in the intermediary platform.

25. A payment method for trading using an IC identification card, the method comprises:
receiving an encrypted user identity information of a user through an identification card reader, the encrypted user identification information including a user identification card number;
receiving a bank account information including a bank account password entered by the user;
receiving a transaction amount entered by a merchant;
sending the encrypted user identity information, the bank account information and the transaction amount to an intermediary platform;
decrypting at least the encrypted user identity information received by the intermediary platform;
sending from the intermediary platform a bank transaction information including the user identity information, the bank account password and the transaction amount to a participating bank subsystem to request a bank transaction; and
if the bank transaction information contains a bank account number, verifying the bank account password, processing at the participating bank subsystem the requested bank transaction, and returning a bank transaction result to the intermediary platform, whereas
if the bank transaction information does not contain a bank account number, finding at the participating bank subsystem the bank account number corresponding to the user identity information, verifying the bank account password, processing the requested bank transaction, and returning a bank transaction result to the intermediary platform.

26. The payment method as recited in claim 25, further comprising:
storing at the intermediary platform a mapping relationship between user identification card numbers and user bank accounts; and
looking up the bank account number corresponding to the user identification card number from the mapping relationship, and if found, sending the bank account number as part of the bank transaction information to the participating bank subsystem.

27. The payment method as recited in claim 25, further comprising:
encrypting the transaction amount using a transaction encryption key; and
encrypting the bank account password using a bank encryption key provided by either the participating bank or a third party.

28. The payment method as recited in claim 25, further comprising:
encrypting the bank account password using either a bank encryption key provided by either the participating bank or a third party; and
including the encrypted bank account password in the bank transaction information sent to the participating bank.

29. The payment method as recited in claim 25, further comprises:
if there exist in the participating bank more than one bank account number corresponding to the user identification card number, sending a notice requesting the user to provide a specific bank account number for the payment.

30. A payment system for trading using an IC identification card, the system comprising:
an accepting device having an IC identification card reader to receive and decrypt an encrypted user identity information from an IC identification card, the accepting device being adapted for further receiving a user bank account information; and
an intermediary platform adapted for
receiving the decrypted user identity information and the user bank account information sent from the accepting device,
communicating a bank transaction information including the user identity information and the user bank account information to a participating bank subsystem to request a bank transaction,
receiving a bank transaction result from the participating bank subsystem, and
communicating the bank transaction result to the accepting device.

31. The payment system as recited in claim 30, wherein the accepting device further has an input unit separate from the IC identification card reader for receiving the user bank account information.

32. The payment system as recited in claim 31, wherein the input unit is used for further receiving a transaction amount.

33. The payment system as recited in claim 30, wherein the user bank account information received by the accepting device includes a bank account password entered by the user.

34. The payment system as recited in claim 30, wherein the accepting device has a cipher for encrypting the user bank account information using a bank encryption key provided by either the participating bank or a third party.

35. The payment system as recited in claim 30, wherein the accepting device further includes:
a first cipher used for decrypting the user identification information; and
a second cipher used for encrypting the user bank account information using a bank encryption key provided by either the participating bank or a third party

36. The payment system as recited in claim 35, wherein at least one of the first cipher and the second cipher is an integral part of the identification card reader.

37. The payment system as recited in claim 35, wherein the accepting device further includes a third cipher used for encrypting a transaction amount received by the accept device.

38. The payment system as recited in claim 30, wherein the accepting device comprises a merchant processing unit connected to the identity card reader, the merchant processing unit including:
an input unit used for receiving external information entered outside of the identification card reader, the external information including at least one of a trade amount entered by a merchant, a bank account password entered by the user, and information of a participating bank chosen by the user;
an output unit used for outputting a transaction result;
a processor used for processing the external information received from by input unit and/or the user identification information received by the IC identification card reader; and
a communication unit used for communicating process information to the intermediary platform.

39. The payment system as recited in claim 38, wherein the merchant processing unit is implemented in a computing device interfacing with the identification card reader, and wherein the output unit includes a display screen.

40. The payment system as recited in claim 30, wherein the intermediary platform further comprises:
a database storage unit storing a mapping relationship between a plurality of bank account numbers and a plurality of user identification card numbers; and
a bank account processing unit for looking up a bank account number corresponding to the identification card number from the mapping relationship, and including the bank account number in the bank transaction information to be communicated to the participating bank subsystem.

41. A payment method for trading using an IC identification card, the method comprises:
receiving an encrypted user identity information of a user through an identification card reader, the encrypted user identification information including a user identification card number;
decrypting the encrypted user identity information received by the identification card reader;
receiving a bank account information including a bank account password entered by the user;
receiving a transaction amount entered by a merchant;
sending the decrypted user identity information, the bank account information and the transaction amount to an intermediary platform;
sending from the intermediary platform a bank transaction information including the user identity information, the bank account password and the transaction amount to a participating bank subsystem to request a bank transaction; and
if the bank transaction information contains a bank account number, verifying the bank account password, processing at the participating bank subsystem the requested bank transaction, and returning a bank transaction result to the intermediary platform, whereas
if the bank transaction information does not contain a bank account number, finding at the participating bank subsystem the bank account number corresponding to the user identity information, verifying the bank account password, processing the requested bank transaction, and returning a bank transaction result to the intermediary platform.

42. The payment method as recited in claim 41, further comprising:
storing at the intermediary platform a mapping relationship between user identification card numbers and user bank accounts; and
looking up the bank account number corresponding to the user identification card number from the mapping relationship, and if found, sending the bank account number as part of the bank transaction information to the participating bank subsystem.
